(19) United States
(12) Patent Application Publication
(10) Pub. No.: US 2024/0349725 A1
(43) Pub. Date: Oct. 24, 2024

(54) FORMULATION COMPRISING AN ACID FUNCTION ACTIVE INGREDIENT, ESTER FUNCTION ACTIVE INGREDIENT AND SALT AND/OR CHEMICALLY LABILE ACTIVE INGREDIENT, THE USE THEREOF AND METHOD OF PRODUCTION

(71) Applicant: Iharabrás S.A. Indústrias Químicas, Sorocaba (BR)

(72) Inventors: Anderson Aparecido de Marchi, Campinas (BR); Diogo Pineda Rivelli, Soracaba (BR)

(21) Appl. No.: 18/699,475

(22) PCT Filed: Oct. 7, 2022
(86) PCT No.: PCT/BR2022/050390

§ 371 Date: Apr. 8, 2024

(30) Foreign Application Priority Data
Oct. 7, 2021 (BR) 1020210201932

(51) Int. Cl. A01N 43/54; A01N 25/04; A01N 37/10; A01N 37/12; A01P 13/00

(52) U.S. Cl. CPC A01N 43/54; A01N 25/04; A01N 37/10; A01N 37/12; A01P 13/00

(57) ABSTRACT

The present invention refers to physicochemically stable formulations that allow the delivery of two, three or more active components having different physicochemical features that are a priori chemically incompatible with each other and in different concentrations as well as the use and method of producing said formulation.

### FIELD OF THE INVENTION

The present invention refers to physicochemically stable formulations that allow the delivery of two, three or more active components having different physicochemical features that are a priori chemically incompatible with each other and in different concentrations.

### BACKGROUND OF THE INVENTION

A common technical problem in the technical field of the present invention is the provision of formulations, preferably herbicide, insecticide, fungicide, acaricide or nematicide formulations that enable the delivery in the same product of two, three or more agricultural pesticides that are a priori chemically incompatible with each other and/or that degrade through reactions involving nucleophilic groups existing in any component present in the formulation (other active ingredients, solvents, surfactants, others).

Formulations, preferably herbicide, insecticide, fungicide, acaricide or nematicide formulations comprising two, three or more agricultural pesticides that are a priori chemically incompatible with each other and/or that degrade by a reaction caused by nucleophiles is of commercial interest, for example, in preparation of an application broth.

When preparing an application broth with the individual products, a farmer would be subject to dosage errors due to the different concentrations of the active ingredient in each product. Thus, by preparing a single formulation that brings together the active ingredients in the same product, whose single formulation is also stable for a long time, it provides convenience to the farmer and reduces, for example, possible dosage errors when preparing the application broth.

Moreover, the combination in the same product of different active ingredients allows different mechanisms of herbicide, insecticide, fungicide, acaricide or nematicide action to be exploited simultaneously, hence improving the effectiveness of the product against a specific target and/or expanding the variety of possible targets.

Of particular interest to the present invention are herbicide, insecticide, fungicide, acaricide or nematicide formulations, preferably herbicide formulations as an emulsifiable concentrate (EC), oil-miscible fluid concentrate (OF), oil-miscible solution (OL) and oil dispersion (OD).

Through the present invention, the formulation of the present invention was found to allow the delivery in the same product of molecules that are a priori incompatible with each other and/or capable of degradation through reactions with nucleophiles (OH, NH₂, NHR, COOH, COO^{—}, SH groups, among others) very commonly found in agrochemical formulations.

Thus, to obtain a formulation, preferably a herbicidal formulation comprising two, three or more agricultural pesticides that are a priori chemically incompatible with each other and/or that degrade by reaction caused by nucleophiles, the inventors of the present invention found it necessary to use, for example, a tertiary alkylamine; an alkyl lactate; an acylating agent; and, optionally, one or more suitable solvents.

It is noted that the prior art neither describes nor suggests the specific use of a tertiary alkylamine; an alkyl lactate; an acylating agent; and, optionally, one or more suitable solvents in the formulations of the present invention that have the functions and objectives disclosed herein.

Thus, the present invention is not described nor is it derived in an obvious manner from any prior art documents, since the delivery in a single product of two, three, or more agricultural pesticides that are a priori chemically incompatible with each other and/or that degrade through a reaction caused by nucleophiles would not be expected.

Through the present invention it was possible to stabilize, in a single formulation, for example, a mixture of at least one or more active ingredients containing an acid function, at least one or more active ingredients containing the ester function and, optionally, at least one or more active saline and/or chemically labile active ingredients.

Particularly preferably, the invention stabilized a mixture comprising an acid-functional active, an ester-functional active and a saline and/or chemically labile active and, in a preferred embodiment of the present invention, a mixture of actives comprising 2,4-dichlorophenoxyacetic acid (2,4-D), lactofen and bispyribac sodium through the use of the following (a)-(d) below:
(a) use of at least one or more tertiary alkylamines, which are basic (react with acids) but are not nucleophilic (are not expected to attack ester bonds or other electrophilic groups). Therefore, one or more tertiary alkylamines have the main role of a neutralizing agent and, depending on their proportion in the formulation, they can also play the role of co-solvent;
(b) use of one or more alkyl lactates to meet, for example, the following needs:
   (i) an anti-crystallizing agent, since crystallization is a common problem in highly concentrated formulations and was an effect observed at the beginning of the development of the present invention (see item (E) of Table 1, below), and in consequence of extremely concentrated active ingredients, such as 2,4-D used in a preferred embodiment of the present invention; and
   (ii) a “sacrificial reagent” in the particular instance of said preferred embodiment of the present invention, preferably lactofen, since part of the lactofen molecule is ethyl lactate and, therefore, if such component is present in sufficient amounts in the medium, through its hydroxyl group, it can compete with any other nucleophilic species present in the same medium, and if it chemically attacks lactofen, the product will be equal to the reactant, thus minimizing the degradation of this compound; and
(c) use of an acylating agent, wherein such reagent was added for the purpose of reducing through a possible reaction of introducing an acyl group, the presence of any nucleophilic groups that could cause degradation, for example, of lactofen and bispyribac sodium, in the particular instance of a preferred embodiment of the present invention.

Residual nucleophilic groups may be present in the medium due to residual water or even other chemical species, such as OH groups from emulsifiers used in the formulation (which is an emulsifiable concentrate), without, however, compromising its emulsifying activity.
(d) use of a chemically suitable solvent, such as, in said preferred embodiment of the present invention, the use of aprotic solvents.

In other words, the state of the art does not describe, mention or suggest a solution to the technical problem of providing formulations, preferably herbicide, insecticide, fungicide, acaricide or nematicide formulations that enable the delivery in the same product of two, three or more agricultural pesticides that are a priori chemically incompatible with each other and/or that degrade through a nucleophile-caused reaction.

In particular, the prior art documents do not solve the technical problem of providing formulations, preferably herbicide formulations, as disclosed herein. Secondary amine salt formulations diethanolamine, diisopropanolamine) of 2,4-D and other herbicides containing a carboxylic acid function (2,4,5-T, ticlopyr, dicamba, picloram, aminopyralid, others) are extremely hydrophilic, being normally conveyed as a concentrated aqueous solution of high pH to avoid crystallization of the salt/free acid. Lactofen, in turn, has limited solubility in water and, due to its high lipid solubility, it is sold commercially dissolved in petroleum-derived solvents. As discussed, these active ingredients have physical-chemical features that make it difficult for them to be used together in the same formulation. In addition to this is the easy decomposition through base-catalyzed hydrolysis, of active ingredients containing the ester function, such as lactofen, if they were soluble or emulsified in an alkaline solution, as is the case of the aqueous solution of amine salts of 2,4-D. This effect was observed when lactofen was dissolved in a naphthenic organic solvent and then emulsified in a solution of 2,4-D dimethylamine salt. Shortly afterwards, lactofen had been decomposed even under mild temperature conditions, which made it impossible to provide this mixture under these conditions as a commercial product. It is also mentioned that, although the degradation kinetics may be different, compounds containing an ester group, such as lactofen, can also undergo solvolysis (hydrolysis if the solvent is water) in the presence of acids, which makes it impossible for lactofen to be transported with 2,4-D without neutralization of the latter by an alkaline compound. Bispyribac sodium is also a compound that easily degrades under different conditions. Literature shows that bispyribac sodium undergoes hydrolysis at pHs below 5, with this compound being fully degraded in the presence of unneutralized 2,4-D due to its high acidity. Bispyribac sodium is also known to only remain stable at pH levels close to neutral or slightly alkaline (7 to 9) and at temperatures around 25° C. and in the dark, with an acceleration of degradation under conditions other than these. These features of lactofen and bispyribac sodium make it difficult for one to develop formulations with other active ingredients, which may justify the absence of commercial products with these associated active ingredients.

Surprisingly, the inventors of the present invention have found that the results obtained using the present invention provide an unexpected and interesting synergistic effect to the industry. The obtained product was shown to be stable under various temperature conditions, including accelerated tests, where the product is subjected to temperatures of up to 54° C. for 14 days. To achieve this effect, it was necessary to minimize the presence of any nucleophilic species in the formulation. Based on this premise, the use of triethylamine, a basic, non-nucleophilic, tertiary amine that is the simplest and most easily manipulated among the trialkyl amines was preferred. However, higher trialkyl amines can be used for the same purpose. Introduction of ethyl lactate can serve three functions:
1) being a reagent that competes with any other residual nucleophilic species that could decompose lactofen;
2) having anti-crystallizing activity, inhibiting the crystallization of the triethylamine salt of 2,4-D, which is very concentrated, helping to stabilize the formulation from a physical-chemical point of view;
3) facilitating the dissolution of bispyribac sodium in the medium. Reduction in the amount of nucleophilic species was further enhanced by acetic anhydride, a potent acylating agent for residual OH, NH₂ and NHR groups that may be present in the medium as a result of moisture and/or mono-and dialkyl triethylamine impurities. The formulation is terminated by choosing a solvent (or mixture of solvents) that is the most suitable, that makes all these compounds compatible with each other and that tends to reduce the speed of any reaction that leads to the decomposition of the active ingredients to zero.

Thus, through the present invention, a synergistic effect of the components of the formulations of the present invention was verified.

Numerous laboratory tests were carried out, and the results and additional evidence of the surprising efficiency, as well as the synergistic effect of the present invention, are reported here. In tables 1, 2 and 3 there are examples where the use of monoalkylamines, dialkylamines, alkanolamines, the absence of an acylating agent and excess of nucleophilic chemical species in the medium lead to high degradation of lactofen and bispyribac sodium, while the use of the components described in paragraphs above preserves the integrity of chemically labile active ingredients even at high temperatures.

### OBJECTIVES OF THE INVENTION

It is one of the objectives of the present invention to provide formulations comprising at least one or more actives containing an acid function, at least one or more actives containing the ester function, and optionally, at least one or more saline and/or chemically labile actives, preferably, wherein the agrochemical formulations of herbicides, insecticides, fungicides, acaricides or nematicides are an emulsifiable concentrate agrochemical formulation, as disclosed in the present invention, but not limited to this type of formulation, with the technology also being applied to oil-miscible fluid concentrate (OF), oil-miscible solution (OL) and oil-dispersion (OD) formulas.

It is also the object of the present invention to provide formulations, preferably herbicide formulations that enable the delivery in the same product, of two, three or more agricultural pesticides that are a priori chemically incompatible with each other and/or that degrade due to a reaction caused by nucleophiles.

It is yet another object of the present invention to reduce product losses, reduce the chances of dosing errors and increase the operational performance, as well as preventing the occurrence of contamination of equipment, people and soil by using the invention disclosed herein.

It is another object of the present invention to provide a method for producing the agrochemical formulations disclosed herein.

It is an additional object of the present invention to provide a formulation that brings together active ingredients that are chemically incompatible with each other and/or that degrade due to a reaction caused by nucleophiles in the same product, wherein the single formulation is also stable for a long period of time.

It is also an object of the present invention to use a tertiary alkylamine, an alkyl lactate, an acylating agent and, optionally, one or more suitable solvents in a single formulation to avoid and/or reduce the degradation of active ingredients that are chemically incompatible with each other and/or or that are degraded by a reaction caused by nucleophiles.

### DESCRIPTION OF THE INVENTION

The present invention refers to physiochemically stable formulations that allow the delivery of two, three or more active components having different physicochemical features that are a priori chemically incompatible with each other and in different concentrations.

The formulation of the present invention is a formulation comprising:
at least one or more active ingredients containing the acid function;
at least one or more active ingredients containing the ester function;
optionally, at least one or more salt and/or chemically labile active ingredients; and
optionally, at least one or more chemically suitable solvents,
wherein said formulation further comprises:
at least one or more tertiary alkylamines;
at least one or more alkyl lactates; and
at least one or more acylating agents.

Of particular interest to the present invention is the possibility of delivery, for example, in a single concentrated, stable herbicide formulation that is chemically compatible with the following three active ingredients:
2,4-dichlorophenoxyacetic acid (2,4-D), or any herbicide from the class of aryloxyacetic, benzoic, pyridine-carboxylic, pyridyloxy-carboxylic, quinoline-carboxylic, phosphinic, phosphonic, sulfonic acids, phenols or derivatives); lactofen and
bispyribac sodium, due to the physical-chemical characteristics of each, namely:
2,4-dichlorophenoxyacetic acid (2,4-D):
an acidic compound, whose concentrated formulas (such as 500 g/L acid equivalent) are only possible after neutralization with an amine.

Several available 2,4-D-based products are aqueous solutions of amine salts such as dimethylamine, diethanolamine, or quaternary ammonium compounds (choline).

In addition to formulas where 2,4-D is delivered alone, only those formulations where 2,4-D is delivered with other acidic herbicides, both neutralized with excess amines, are known.

Lactofen: chemically labile compound (due to the ester bond), which is commercially available only in emulsifiable concentrate formulations based on petroleum solvents (a very inert solvent from a chemical point of view). There is no known presentation of this herbicide in association with others in the same product.

Bispyribac sodium: The literature mentions that this compound is hydrolyzed at a pH equal to or lower than 5, resulting in at least 5 identified products.

Regarding stability in organic solvents, the same degradation pathway as reported in the literature is considered when such a compound is placed in the presence of water.

Internally, it is observed that this compound degrades easily in the presence of acids, even in the absence of water.

Some products are available on the market and are usually sold as a concentrated suspension in a buffered aqueous medium at a neutral to slightly alkaline pH (pH 7.5-10.0). There is no known presentation of this herbicide in association with others in the same product.

Said preferred embodiment of the present invention, namely, the stable herbicidal formulation comprising 2,4-D, Lactofen and bispyribac sodium has been achieved due to at least the use of the following features (a)-(d):
(a) Preferential use of anhydrous triethylamine: anhydrous triethylamine is preferably used as a neutralizer for 2,4-D since it is common for 2,4-D to be delivered as an amine salt.

It is worth highlighting the possibility of using any tertiary alkylamine, which are basic (they react with acids), but not nucleophilic (they are not expected to attack ester bonds or other electrophilic groups).

We specifically chose to use triethylamine due to cost and availability, however, it should be noted that others trialkyl amines, such as tripropylamine, triisopropylamine, tributylamine, diisopropylethylamine, and so on could be used.
(b) Preferential use of ethyl lactate. Use of this component was intended to meet at least the following needs:
   (i) an anti-crystallizing agent, since crystallization was an effect frequently observed at the beginning of development (see item (E) of Table 1, below, in view of one of the extremely concentrated active ingredients (2,4-D)); and
   (ii) due to its polarity, it facilitates the dissolution of bispyribac sodium in the formulation medium
   (iii) as a “sacrificial reagent” in the specific case of lactofen.

Part of the lactofen molecule is exactly ethyl lactate, so if this component is present in sufficient amount in the medium, it can compete with any other nucleophilic species in the same medium, and if it chemically attacks the aromatic carbonyl of lactofen, the product will be equal to the reagent, thus minimizing compound degradation, see the diagram reproduced below:

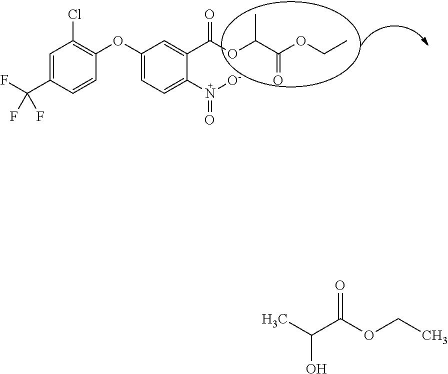

It is also worth highlighting the fact that ethyl lactate, for being a polar liquid, helps to solubilize the salt, bispyribac sodium, in the medium.
(b) Use of acetic anhydride. This reagent is added as an acylating agent for the purpose of reducing through a possible acetylation reaction the presence of any nucleophilic groups that could degrade lactofen and bispyribac sodium.

It is reiterated that residual nucleophilic groups may be present in the medium due to residual water or even other chemical species, such as OH groups from emulsifiers used in the formulation (which is an emulsifiable concentrate), or monoalkyl and dialkylamines as impurities of the trialkylamines used to neutralize 2,4-D. However, the possible acetylation of nucleophilic groups in these agents should not compromise their emulsifying activity.

Below we demonstrate a possible degradation reaction of lactofen and the expected general acetylation reaction between acetic anhydride and the residual hydroxyls of the block copolymer, a common emulsifier used in EC formulations.

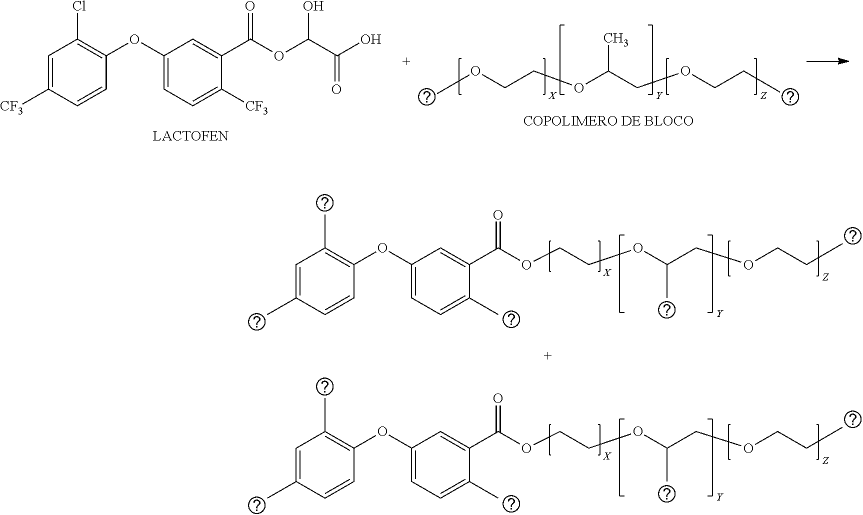

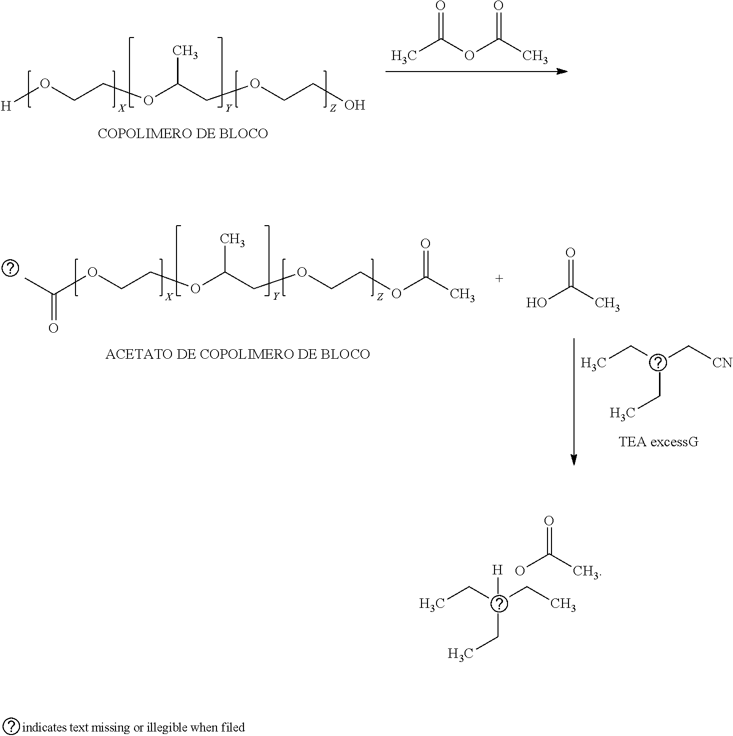

(d) Suitable solvent. The most promising results of the preferred embodiment of the present invention (>80% recovery of active ingredients, with a recovery exceeding 95% in some instances) were obtained with aprotic solvents (DMSO, acetophenone, and the like).

The inventors of the present invention have surprisingly found that the use of, for example, a tertiary alkylamine; an alkyl lactate; an acylating agent; and, optionally, one or more suitable solvents enable the provision of a formulation, preferably a herbicidal formulation comprising two, three or more agricultural pesticides that are a priori chemically incompatible with each other and/or that degrade through a reaction caused by nucleophiles.

Thus, through the use of, for example, a tertiary alkylamine; an alkyl lactate; an acylating agent; and, optionally, one or more suitable solvents, a formulation that brings together actives that are a priori chemically incompatible with each other and/or that degrade due to a reaction caused by nucleophiles in the same product was provided, whose single formulation is also stable for a long time period of time.

A synergistic effect was also found when using the formulation of the present invention as follows, and as further demonstrated in the examples of the present invention:
A herbicidal formulation comprising:
   from 100 to 800 g/L 2,4-dichlorophenoxyacetic acid (2,4-D) as an active ingredient containing the acid function;
   from 10 to 400 g/L lactofen as an active ingredient containing the ester function;
   from 2.5 to 200 g/L bispiribac sodium as a salt and/or chemically labile active ingredient;
   wherein the composition further comprises triethylamine in an amount of from 0.8 to 3.0 times the molar amount relative to the acid; from 10 to 100 g/L of ethyl lactate; from 10 to 100 g/L acetic anhydride; from 5 to 150 g/L surfactant; and solvent q.s.p.
A herbicidal formulation comprising:
   from 400 to 600 g/L 2,4-dichlorophenoxyacetic acid (2,4-D) as an active ingredient containing the acid function;
   from 40 to 100 g/L lactofen as an active ingredient containing the ester function;
   from 4 to 20 g/L bispyribac sodium as a salt and/or chemically labile active ingredient;
   wherein the composition further comprises triethylamine in an amount of from 1.0 to 2.0 times the molar amount relative to the acid; from 20 to 50 g/L ethyl lactate; from 20 to 40 g/L acetic anhydride; from 10 to 50 g/L surfactant; and solvent q.s.p.

Examples of preferred embodiments of the present invention are:
1. A formulation comprising:
   at least one or more active ingredients containing the acid function;
   at least one or more active ingredients containing the ester function;
   optionally, at least one or more salt and/or chemically labile active ingredients; and
   optionally, at least one or more chemically suitable solvents,
   wherein said formulation further comprises:
   at least one or more tertiary alkylamines;
   at least one or more alkyl lactates; and
   at least one or more acylating agents.
2. The formulation disclosed herein, which is a herbicidal formulation, wherein:
   (i) the at least one or more active ingredients containing the acid function are selected from the following classes of acids: carboxylic acid, phosphoric acid, phosphonic acid, phosphonic acid, sulfuric acid, sulfonic acid, carbonic acid, phenol, 1,3-dicarbonyls and derivatives thereof, preferably, wherein the at least one or more active ingredients containing the acid function is 2,4-dichlorophenoxyacetic acid (2,4-D), glyphosate, 2,4,5-T, 2,4-DB, MCPA, MCPB, clomeprop, dichlorprop, mecoprop, aminopyralid, clopyralid, aminocyclopyrachlor, florpyrauxifen, halauxifen, quinclorac, picloram, chloramben, fluroxypyr, triclopyr, dicamba, fenthiaprop or neptalam, more preferably, wherein the at least one or more active ingredients containing the acid function is 2,4-D;
   (ii) the at least one or more active ingredients containing the ester function is selected from lactofen, flumiclorac pentyl, carfentrazone ethyl, pyrazosulfuron ethyl, quizalofop ethyl, haloxyfop methyl, fenoxaprop ethyl, clodinafop propargyl, cialofop butyl, diclofop methyl, fluazifop butyl, preferably, wherein the at least one or more active ingredients containing the ester function is lactofen;
   (iii) the at least one or more salt and/or chemically labile active ingredients is selected from bispyribac sodium, sodium pyrithiobac, tolpiralate, fomesafen sodium, ammonium glyphosinate, metamifop, tridiphane, indanofan, thenilchlor, propisochlor, propachlor, pretilachlor, metolachlor, pethoxamid, alachlor, butachlor, dimetachlor, metazachlor or dimethenamid, preferably, the at least one or more salt and/or chemically labile active ingredients is bispyribac sodium;
   (iv) the at least one or more chemically suitable solvents is a chemically suitable solvent selected from aprotic solvents, preferably wherein the at least one or more chemically suitable solvents is selected from among DMSO, acetophenone, N-methyl-2-pyrrolidone, N,N-dimethylacetamide, N,N-dimethylformamide, ethylene glycol dialkyl ethers, propylene glycol dialkyl ethers, butylene glycol dialkyl ethers, triacetin, trialkylglycerin and triacylglycerin derivatives and other alkyl alkylates.
3. The formulation, disclosed herein, wherein the at least one or more tertiary alkylamines is selected from trialkylamines, such as triethylamine, tripropylamine, triisopropylamine, tributylamine, diisopropylethylamine, preferably, wherein the at least one or more tertiary alkylamines is anhydrous triethylamine.
4. The formulation, as disclosed herein, wherein the at least one or more alkyl lactates is selected from methyl lactate, ethyl lactate, n-propyl lactate, iso-propyl lactate, ethyl hexyl lactate, preferably wherein the at least one or more alkyl lactates is ethyl lactate.
5. The formulation, as disclosed herein, wherein at least one or more acylating agents is selected from acetic anhydride, propionic anhydride, phthalic anhydride and acyl chlorides of different carbon chain sizes, preferably, wherein the at least one or more acylating agents is acetic anhydride.
6. The formulation disclosed herein, which is an herbicidal formulation comprising:
   2,4-dichlorophenoxyacetic acid (2,4-D) as an acid function-containing active ingredient,
   lactofen as an ester function-containing active ingredient,
   bispyribac sodium as a salt and/or chemically labile active ingredient.
7. The formulation, as disclosed herein, which further comprises:
   (i) at least one or more tertiary alkylamines, wherein the at least one or more tertiary alkylamines is selected from trialkylamines, such as triethylamine, tripropylamine, triisopropylamine, tributylamine, diisopropylethylamine, more preferably, wherein the at least one or more tertiary alkylamines is anhydrous triethylamine.
   (ii) at least one alkyl lactate selected from methyl lactate, ethyl lactate, n-propyl lactate, iso-propyl lactate, ethyl hexyl lactate, preferably, wherein the at least one alkyl lactate is ethyl lactate.
   (iii) at least one acylating agent selected from acetic anhydride, propionic anhydride, phthalic anhydride, and acyl chlorides of different carbon chain sizes, preferably wherein the at least one acylating agent is acetic anhydride.
8. The formulation disclosed herein, which is a herbicidal formulation comprising:
   from 100 to 800 g/L 2,4-dichlorophenoxyacetic acid (2,4-D) as an active ingredient containing the acid function;
   from 10 to 400 g/L lactofen as an active ingredient containing the ester function;
   from 2.5 to 200 g/L bispyribac sodium as a salt and/or chemically labile active ingredient;
   wherein the composition further comprises triethylamine in an amount of from 0.8 to 3.0 times the molar amount relative to the acid; from 10 to 100 g/L of ethyl lactate; from 10 to 100 g/L acetic anhydride; from 5 to 150 g/L one or more surfactants; and solvent q.s.p.
9. The formulation disclosed herein, which is a herbicidal formulation comprising:
   from 400 to 600 g/L 2,4-dichlorophenoxyacetic acid (2,4-D) as an active ingredient containing the acid function;
   from 40 to 100 g/L lactofen as an active ingredient containing the ester function;
   from 4 to 20 g/L bispyribac sodium as a salt and/or chemically labile active ingredient;
   wherein the composition further comprises triethylamine in an amount of from 1.0 to 2.0 times the molar amount relative to the acid; from 20 to 50 g/L ethyl lactate; from 20 to 40 g/L acetic anhydride; from 10 to 50 g/L surfactant; and solvent q.s.p.
10. The formulation, as disclosed herein, which is an emulsifiable concentrate herbicide formulation, which can extend to oil-miscible fluid concentrate (OF), oil-miscible solution (OL) and oil dispersion (OD).
11. Use of a tertiary alkylamine, an alkyl lactate, an acylating agent and, optionally, one or more suitable solvents in a formulation, as disclosed herein, in a single formulation which is intended to prevent and/or decrease the degradation of chemically active ingredients that are incompatible with each other and/or that degrade by a reaction caused by nucleophiles.
12. Use as disclosed herein, wherein the tertiary alkylamine is selected from trialkylamines, such as triethylamine, tripropylamine, triisopropylamine, tributylamine, diisopropylethylamine, preferably, wherein the tertiary alkylamine is anhydrous triethylamine.
13. The use as disclosed herein, wherein the alkyl lactate is selected from methyl lactate, ethyl lactate, n-propyl lactate, iso-propyl lactate, ethyl-hexyl lactate, preferably, wherein the alkyl lactate is ethyl lactate.
14. The use as disclosed herein, wherein the acylating agent is selected from acetic anhydride, propionic anhydride, phthalic anhydride and acyl chlorides of different carbon chain sizes, preferably, wherein the acylating agent is acetic anhydride.
15. Use of a formulation, as disclosed herein, to prevent and/or reduce the degradation of active ingredients that are chemically incompatible with each other and/or that are degraded by a reaction caused by nucleophiles.
16. Method of preparing a formulation, as disclosed herein, comprising the steps of:
   (a) adding the at least one or more chemically suitable solvents and at least one or more alkyl lactates;
   (b) adding to the solution obtained in step (a) the at least one or more tertiary alkylamines followed by at least one or more active ingredients containing the acid function, controlling the temperature and stirring the mixture;
   (c) stirring until total dissolution of at least one or more acid function containing-active ingredients and up to a suitable temperature of the reaction medium;
   (e) adding at least one or more acylating agents, followed by the salt and/or chemically labile active ingredient(s), followed by stirring until the salt is completely dissolved; and
   (f) adding at least one or more ester function-containing active ingredients; optionally stirring the mixture obtained until a homogeneous mixture is achieved, and optionally adding additional components, such as surfactants, emulsifiers, dispersants, surfactants and/or others, if any.
17. Method of using a tertiary alkylamine, an alkyl lactate, an acylating agent and, optionally, one or more suitable solvents in a formulation as disclosed herein, wherein it is to obtain a single formulation, preferably a herbicidal formulation comprising two, three or more active ingredients that are chemically incompatible with each other and/or that degrade due to a reaction caused by nucleophiles.
18. The method as disclosed herein, wherein the tertiary alkylamine is selected from trialkylamines, such as tripropylamine, triisopropylamine, tributylamine, diisopropylethylamine, preferably, wherein the tertiary alkylamine is anhydrous triethylamine.
19. The method as disclosed herein, wherein the alkyl lactate is selected from methyl lactate, ethyl lactate, n-propyl lactate, iso-propyl lactate, ethylhexyl lactate, preferably, wherein the alkyl lactate is ethyl lactate.
20. The method as disclosed herein, wherein the acylating agent is selected from acetic anhydride, propionic anhydride, phthalic anhydride and acyl chlorides of different carbon chain sizes, preferably, wherein the acylating agent is acetic anhydride.

### EXAMPLES AND TESTS

Examples of embodiments will be provided below, which are merely exemplary in nature and are not intended to limit or restrict the subject matter of the present patent application.

Assessment methodology: Chemical stability was confirmed through accelerated studies at 0° C., 54° C., 0-54° C. cycles and room temperature, which can be considered representative of 2 years of shelf life.

Formulations where all active ingredients were recovered in amounts >95% under all tested conditions are considered stable (100% is the % of active ingredients found in the formulation at 0° C., where it is assumed that there is no degradation).

Operating conditions: The following examples are procedures for preparing formulations representative of embodiments of the present invention:

### Example 1—Formulation 2.54 of Tables 2 and 3

In a container, add 165 g acetophenone and 30 g ethyl lactate. Add 344 g of triethylamine followed by 500 g of 2,4-D to this mixture. Stir until the 2,4-D is completely dissolved. Stirring continues until the temperature of the reaction medium drops below 40° C. Add 26 g of acetic anhydride and, if the temperature rises, wait for it to return to around 40° C. Add 5 g of bispyribac sodium and stir until the salt is completely dissolved. Add 60 g of molten lactofen and stir until a homogeneous mixture is obtained. Add 10 g of ethoxy-propoxy block copolymer and stir until a homogeneous mixture is obtained. The mixture is passed through #325 mesh before filling (formula 2.54).

| | | Accelerated stability Results - | | | Accelerated stability results - | | | Accelerated stability results - | | |
|---|---|---|---|---|---|---|---|---|---|---|
| | | 14 Days Room Temperature | | | 14 Day Cycle (0° C. to 54° C.) | | | 14 days at 54° C. | | |
| | Type of | 2,4-D | Lactofen | Bispyribac | 2,4-D | Lactofen | Bispyribac | 2,4-D | Lactofen | Bispyribac |
| | Formulation | (%) | (%) | sodium (%) | (%) | (%) | sodium (%) | (%) | (%) | sodium (%) |
| 2.54 | EC | 100.5 | 99.8 | 102.4 | 101.4 | 100.2 | 103.9 | 102.5 | 95.2 | 96.3 |

Surprisingly, it was therefore found that a stable formulation was obtained since all of the 3 active ingredients, a priori incompatible with each other, were recovered after the sample was subjected to accelerated stability tests.

### Example 2: Formulation 2.20 of Tables 2 and 3

In a container, add 80 g dimethyl sulfoxide and 30 g ethyl lactate. Add 188 g triethylamine followed by 250 g 2,4-D to this mixture. Stir until the 2,4-D is completely dissolved. Add a new 188 g portion of triethylamine followed by 250 g 2,4-D and stir until the 2,4-D dissolves. Stirring continues until the temperature of the reaction medium drops below 40° C. 10 g of acetic anhydride is added and, if the temperature rises, wait for it to return to around 40° C. Add 5 g bispyribac sodium and stir until the salt is completely dissolved. Add 60 g of molten lactofen and stir until a homogeneous mixture is obtained. Add 10 g of ethoxy-propoxy block copolymer and stir until a homogeneous mixture is obtained. The mixture is passed through #325 mesh before filling (formula 2.20).

| | | Accelerated stability Results - | | | Accelerated stability results - | | | Accelerated stability results - | | |
|---|---|---|---|---|---|---|---|---|---|---|
| | | 14 Days Room Temperature | | | 14 Day Cycle (0° C. to 54° C.) | | | 14 days at 54° C. | | |
| | Type of | 2,4-D | Lactofen | Bispyribac | 2,4-D | Lactofen | Bispyribac | 2,4-D | Lactofen | Bispyribac |
| | Formulation | (%) | (%) | sodium (%) | (%) | (%) | sodium (%) | (%) | (%) | sodium (%) |
| 2.20 | EC | 99.6 | 99.3 | 100.0 | 100.3 | 95.4 | 93.6 | 102.1 | 90.3 | 85.1 |

Surprisingly, it was therefore found that recovery of the active ingredients was achieved to a reasonable degree (greater than 85%) under the different conditions of the accelerated stability test.

### Example 3: Formulation 2.01 of Tables 2 and 3

In a container add 158.8 g dimethyl sulfoxide and 83.6 g 99% diethanolamine. 178.7 g of 2,4-D are added to this mixture. Stir until the 2,4-D is completely dissolved. Add 1.8 g bispyribac sodium and stir until the salt is completely dissolved. Add 22.1 g of molten lactofen and stir until a homogeneous mixture is obtained. The mixture is passed through #325 mesh before filling (formula 2.01).

| | | Accelerated stability Results - | | | Accelerated stability results - | | | Accelerated stability results - | | |
|---|---|---|---|---|---|---|---|---|---|---|
| | | 14 Days Room Temperature | | | 14 Day Cycle (0° C. to 54° C.) | | | 14 days at 54° C. | | |
| | Type of | 2,4-D | Lactofen | Bispyribac | 2,4-D | Lactofen | Bispyribac | 2,4-D | Lactofen | Bispyribac |
| | Formulation | (%) | (%) | sodium (%) | (%) | (%) | sodium (%) | (%) | (%) | sodium (%) |
| 2.01 | EC | 102.3 | 97.7 | 89.5 | 107.2 | 41.8 | 34.2 | 109.3 | 17.4 | 10.5 |

Surprisingly, it was therefore found that the use of diethanolamine instead of triethylamine caused considerable degradation of bispyribac sodium and lactofen under the various conditions of the accelerated stability test (almost complete when the formulation was subjected to 54° C. for 14 days).

TABLE 1
Table 1 describes formulations showing physical-chemical instability:

| | Type of | 2,4-D | Solvent | Solvent | Solvent |
|---|---|---|---|---|---|
| | Formulation | Neutralizer | 1 | 2 | 3 |
| 1.01 | emulsion | NaOH | Water | DMSO | HC |
| 1.02 | emulsion | KOH | Water | DMSO | HC |
| 1.03 | emulsion | KOH | Water | HC | — |
| 1.04 | EC | Ethylenediamine | DMSO | — | — |
| 1.05 | EC | Triethanolamine | DMSO | Ethylene | — |
| | | | | glycol | |
| 1.06 | EC | Triethanolamine | DMSO | — | — |
| 1.07 | EC | Diethanolamine | Ethylene | Acetophenone | — |
| | | | glycol | | |
| 1.08 | EC | DMA | Water | DMSO | Benzylic |
| | | | | | alcohol |
| 1.09 | EC | DMA | Water | Ethanol | DMSO |
| 1.10 | EC | DMA | Water | Isopropanol | — |
| 1.11 | EC | DMA | Isopropanol | Water | — |
| 1.12 | EC | DMA | Water | — | — |
| 1.13 | EC | DMA | Water | — | — |
| 1.14 | EC | DMA | Water | — | — |
| 1.15 | EC | Monoethanolamine | Water | — | — |
| 1.16 | EC | Diethanolamine | Water | — | — |
| 1.17 | CS | Ethylenediamine | Water | HC | — |
| 1.18 | CS | Diethanolamine | Water | HC | — |
| 1.19 | OD | piperazine | Soy methyl | — | — |
| | | | ester | | |

| | Anti- | Surfactant | Surfactant | Surfactant | |
|---|---|---|---|---|---|
| | crystallizing | 1 | 2 | 3 | Result |
| 1.01 | — | — | — | — | Low solubility |
| | | | | | of 2,4-D salt |
| | | | | | in the aqueous |
| | | | | | phase, hardened |
| | | | | | formulation |
| 1.02 | — | — | — | — | 2,4-D K salt |
| | | | | | swelled in |
| | | | | | the medium |
| 1.03 | — | — | — | — | 2,4-D K salt |
| | | | | | swelled in |
| | | | | | the medium |
| 1.04 | Ethyl | — | — | — | Precipitation |
| | lactate | | | | |
| 1.05 | — | — | — | — | Crystallization |
| | | | | | at 0° C. |
| 1.06 | — | — | — | — | Cloudy |
| | | | | | formulation |
| 1.07 | — | — | — | — | Cloudy |
| | | | | | formulation |
| 1.08 | Glycerin | Ca alkylbenzene | Polyarylphenol | — | Precipitation |
| | | sulfonate | ethoxylate | | |
| 1.09 | Glycerin | K salt of | Polyarylphenol | — | Precipitation |
| | | polyoxyethylene | ethoxylate | | |
| | | triesterylphenol | | | |
| 1.10 | Propylene | K salt of | Polyarylphenol | — | Cloudy |
| | glycol | polyoxyethylene | ethoxylate | | formulation |
| | | triesterylphenol | | | |
| 1.11 | Glycerin | K salt of | Polyarylphenol | — | Precipitation |
| | | polyoxyethylene | ethoxylate | | |
| | | triesterylphenol | | | |
| 1.12 | Propylene | Acyl | Polyarylphenol | — | Precipitation |
| | glycol | polyglycoside | ethoxylate | | |
| 1.13 | Propylene | Acyl | Polyarylphenol | Lauric | Precipitation |
| | glycol | polyglycoside | ethoxylate | alcohol | |
| | | | | 6 EO | |
| 1.14 | Ethylene | Ethoxypropoxy | Polyarylphenol | — | Highly viscous |
| | glycol | block copolymer | ethoxylate | | formulation |
| 1.15 | — | Polyarylphenol | — | — | Precipitation |
| | | ethoxylate | | | |
| 1.16 | — | Polyarylphenol | — | — | Cloudy |
| | | ethoxylate | | | formulation |
| 1.17 | — | Polysorbate 80 | — | | Precipitation |
| 1.18 | — | Polysorbate 80 | — | — | Slurry |
| | | | | | formulation |
| 1.19 | — | Ca alkylbenzene | Castor oil | — | Slurry |
| | | sulfonate | 40 EO | | formulation |

Note:
EC: Emulsifiable concentrate; CS: suspension encapsulated in carnauba wax; OD: oil dispersion; DMA; 60% dimethylamine in water; DMSO: dimethyl sulfoxide; HC: naphthenic aromatic hydrocarbon.

TABLE 2
Composition of the formulations
Tables 2 and 3: Tables 2 and 3 describe formulations and their
data on the content of each of the active ingredients under
different conditions of the accelerated shelf-life test:

| | Technology/Type | 2,4-D | | Anti- | | |
|---|---|---|---|---|---|---|
| | of formulation | Neutralizer | Solvent(s) | crystallizing | Surfactant(s) | Stabilizing agent(s) |
| 2.01 | EC | Diethanolamine | DMSO | — | — | — |
| 2.02 | EC | Diethanolamine | DMSO | — | — | Ethylenediaminetetraacetic |
| | | | | | | acid |
| 2.03 | EC | Diethanolamine | DMSO | — | — | Ascorbic acid |
| 2.04 | EC | Diethanolamine | DMSO | Ethyl lactate | — | — |
| 2.05 | EC | Triethylamine | DMSO | — | — | — |
| 2.06 | EC | Triethylamine | DMSO | Ethyl lactate | Block copolymer | — |
| 2.07 | EC | Triethylamine | DMSO | Ethyl lactate | Block copolymer | — |
| 2.08 | EC | Triethylamine | DMSO | Ethyl lactate | Block copolymer | — |
| 2.09 | EC | Triethylamine | DMSO | Ethyl lactate | Block copolymer | — |
| 2.10 | EC | Triethylamine | DMSO | Ethyl lactate | Polyarylphenol | — |
| | | | | | ethoxylate | |
| 2.11 | EC | Triethylamine | DMSO | Ethyl lactate | Block copolymer | — |
| 2.12 | EC | Triethylamine | DMSO | Ethyl lactate | Ethoxy-propoxy | — |
| | | | | | monobutyl ether | |
| | | | | | block copolymer | |
| 2.13 | EC | Triethylamine | DMSO | Ethyl lactate | — | — |
| 2.14 | EC | Triethylamine | DMSO | Ethyl lactate | — | — |
| 2.15 | EC | Triethylamine | DMSO | Ethyl lactate | Acrylic polymer | — |
| 2.16 | EC | Triethylamine | Ethyl lactate | — | Block copolymer | Ethylenediaminetetraacetic |
| | | | | | | acid |
| 2.17 | EC | Triethylamine | Ethyl lactate | — | Block copolymer | Butyl hydroxy toluene |
| 2.18 | EC | Triethylamine | Ethyl lactate | — | Block copolymer | Benzophenone derivative |
| 2.19 | EC | Triethylamine | Ethyl lactate | — | Block copolymer | Butylhydroxytoluene + |
| | | | | | | Benzophenone derivative + |
| | | | | | | Ethylenediaminetetraacetic |
| | | | | | | acid |
| 2.20 | EC | Triethylamine | DMSO | Ethyl lactate | Block copolymer | Acetic anhydride |
| 2.21 | EC | Triethylamine | DMSO | Ethyl lactate | Block copolymer | Acetic anhydride |
| 2.22 | EC | Triethylamine | DMSO | Ethyl lactate | Block copolymer | Acetic anhydride |
| 2.23 | EC | Triethylamine | DMSO | Ethyl lactate | Block copolymer | Acetic anhydride |
| 2.24 | EC | Triethylamine | DMSO | Ethyl lactate | Sodium dodecyl | Acetic anhydride |
| | | | | | sulfate | |
| 2.25 | EC | Triethylamine | DMSO | Ethyl lactate | fatty acid | Acetic anhydride |
| | | | | | sodium salt | |
| 2.26 | EC | Triethylamine | DMSO | Ethyl lactate | Block copolymer | Acetic anhydride |
| 2.27 | EC | Triethylamine | DMSO | Ethyl lactate | Block copolymer | — |
| 2.28 | EC | Triethylamine | DMSO + Triacetin | — | Block copolymer | Acetic anhydride |
| 2.29 | EC | Triethylamine | DMSO + Triacetin | — | Sodium lauryl | Acetic anhydride |
| | | | | | sulfate | |
| 2.30 | EC | Triethylamine | DMSO | Ethyl lactate | Soy lecithin | Acetic anhydride |
| 2.31 | EC | Triethylamine | DMSO | Ethyl lactate | Block copolymer | Acetic anhydride |
| 2.32 | EC | Triethylamine | DMSO + Triacetin | — | Block copolymer | Acetic anhydride |
| 2.33 | EC | Triethylamine | DMSO + Triacetin | — | Block copolymer | Acetic anhydride + |
| | | | | | | Ethylenediaminetetraacetic |
| | | | | | | acid |
| 2.34 | EC | Triethylamine | DMSO | Ethyl lactate | Block copolymer | Acetic anhydride |
| 2.35 | EC | Triethylamine | DMSO | Ethyl lactate | Block copolymer | Acetic anhydride + |
| | | | | | | Ethylenediaminetetraacetic |
| | | | | | | acid |
| 2.36 | EC | Triethylamine | Surfom CE 8115 | Ethyl lactate | Block copolymer | Acetic anhydride |
| 2.37 | EC | Triethylamine | Butyl glycol acetate | Ethyl lactate | Block copolymer | Acetic anhydride |
| 2.38 | EC | Triethylamine | MEK | Ethyl lactate | Block copolymer | Acetic anhydride |
| 2.39 | EC | Triethylamine | Propylglycol | Ethyl lactate | Block copolymer | Acetic anhydride |
| 2.40 | EC | Triethylamine | Diethylene glycol | Ethyl lactate | Block copolymer | Acetic anhydride |
| 2.41 | EC | Triethylamine | DMSO | Ethyl lactate | Block copolymer | Acetic anhydride |
| 2.42 | EC | Triethylamine | DMSO | Ethyl lactate | Block copolymer | Acetic anhydride + |
| | | | | | | Butyl hydroxy toluene |
| 2.43 | EC | Triethylamine | Ethyl glycol acetate | Ethyl lactate | Block copolymer | Acetic anhydride + |
| | | | | | | Butyl hydroxy toluene |
| 2.44 | EC | Triethylamine | N,N-dimethyldecanamide | Ethyl lactate | Block copolymer | Acetic anhydride |
| 2.45 | EC | — | N,N-dimethyldecanamide | Ethyl lactate | Block copolymer | Acetic anhydride |
| 2.46 | EC | Triethylamine | Ethyl lactate | Ethyl lactate | Block copolymer | Acetic anhydride |
| 2.47 | EC | Triethylamine | N-methyl pyrrolidone | Ethyl lactate | Block copolymer | Acetic anhydride |
| 2.48 | EC | Triethylamine | Acetophenone | Ethyl lactate | Block copolymer | Acetic anhydride |
| 2.49 | EC | Triethylamine | N,N-dimethyllactamide | Ethyl lactate | Block copolymer | Acetic anhydride |
| 2.50 | EC | Triethylamine | Soy methyl ester | Ethyl lactate | Block copolymer | Acetic anhydride |
| 2.51 | EC | Triethylamine | HC | Ethyl lactate | Block copolymer | Acetic anhydride |
| 2.52 | EC | Triethylamine | Triacetin | — | Block copolymer | Acetic anhydride |
| 2.53 | EC | Triethylamine | Triacetin | Ethyl lactate | Block copolymer | Acetic anhydride |
| 2.54 | EC | Triethylamine | Acetophenone | Ethyl lactate | Block copolymer | Acetic anhydride |
| 2.55 | EC | Triethylamine | Acetophenone | Ethyl lactate | Block copolymer | Acetic anhydride |
| 2.56 | EC | Triethylamine | Acetophenone | Ethyl lactate | Block copolymer | Acetic anhydride |
| 2.57 | EC | Triethylamine | Acetophenone | Ethyl lactate | Block copolymer | Acetic anhydride |
| 2.58 | EC | Triethylamine | Acetophenone | Ethyl lactate | Block copolymer | Acetic anhydride |
| 2.59 | EC | Triethylamine | Acetophenone | Ethyl lactate | Block copolymer | Acetic anhydride |
| 2.60 | EC | Triethylamine | DMSO | Ethyl lactate | Block copolymer | Acetic anhydride |
| 2.61 | EC | Triethylamine | DMSO | Ethyl lactate | Block copolymer | Acetic anhydride |
| 2.62 | EC | Triethylamine | DMSO | Ethyl lactate | Block copolymer | Acetic anhydride |
| 2.63 | EC | Triethylamine | DMSO | Ethyl lactate | Block copolymer | Acetic anhydride |
| 2.64 | EC | Triethylamine | DMSO + butyl | Ethyl lactate | Block copolymer | Acetic anhydride |
| | | | glycol acetate | | | |
| 2.65 | EC | Triethylamine | DMSO | Ethyl lactate | Block copolymer | Acetic anhydride + anhydrous |
| | | | | | | citric acid + hydroxypropyl |
| | | | | | | trimethylammonium chloride + |
| | | | | | | guar |
| 2.66 | EC | Triethylamine | DMSO | Ethyl lactate | Block copolymer | Acetic anhydride + anhydrous |
| | | | | | | citric acid + hydroxypropyl |
| | | | | | | trimethylammonium chloride + |
| | | | | | | guar |
| 2.67 | EC | Triethylamine | DMSO | Ethyl lactate | Block copolymer | Acetic anhydride + anhydrous |
| | | | | | | citric acid + hydroxypropyl |
| | | | | | | trimethylammonium chloride + |
| | | | | | | guar |
| 2.68 | CS2 | Triethylamine | Butyl Glycol | Ethyl lactate | Block copolymer | Acetic anhydride + Ethyl |
| | | | Acetate + MEK | | | cellulose |
| 2.69 | CS3 | Triethylamine | DMSO | Ethyl lactate | Na dodecylbenzene | Acetic anhydride + urea |
| | | | | | sulfonate | formaldehyde resin |
| 2.70 | CS3 | Triethylamine | DMSO | Ethyl lactate | Na dodecylbenzene | Acetic anhydride + urea |
| | | | | | sulfonate | formaldehyde resin |
| 2.71 | EC | — | Methanol + Soy | — | Ca Dodecyl benzene | — |
| | | | methyl ester | | sulfonate/Castor | |
| | | | | | oil 40 EO | |
| 2.72 | EC | — | Methanol + HC + | — | Ca Dodecyl benzene | — |
| | | | soy methyl ester | | sulfonate/Castor | |
| | | | | | oil 40 EO | |
| 2.73 | ME | Triethylamine | Water + DEV | — | Atlox CS 11 | — |
| | | | BR 3108 | | | |
| 2.74 | CS1 | Diethanolamine | Water + HC | — | Polysorbate 80 | — |
| 2.75 | EC | Triethylamine | Acetophenone | Ethyl lactate | Block copolymer | Acetic anhydride |

EC: Emulsifiable concentrate; ME: Microemulsion; CS1: suspension encapsulated in carnauba wax; CS2: suspension of bispyribac sodium encapsulated in ethyl cellulose; CS3: suspension of bispyribac sodium encapsulated in urea-formaldehyde resin; DMSO: dimethyl sulfoxide; HC: naphthenic aromatic hydrocarbon; MEK: methyl ethyl ketone.

TABLE 3
Recovery of each of the actives under different accelerated stability test conditions

| | Shelf-life | | | | | | | | | |
|---|---|---|---|---|---|---|---|---|---|---|
| | results - 14 | Shelf-life results - | | | Shelf-life results - | | | Shelf-life results - | | |
| | days at 0° C. | 14 days Room temperature | | | 14 days Cycle (0° C. to 54° C.) | | | 14 days at 54° C. | | |
| | 2,4D/Lactofen/ | | | Bispyribac | | | Bispyribac | | | Bispyribac |
| | Bispyribac | 2,4-D | Lactofen | sodium | 2,4-D | Lactofen | sodium | 2,4-D | Lactofen | sodium |
| | (%) | (%) | (%) | (%) | (%) | (%) | (%) | (%) | (%) | (%) |
| 2.01 | 100.0 | 102.3 | 87.7 | 89.5 | 107.2 | 41.8 | 34.2 | 109.3 | 17.4 | 10.5 |
| 2.02 | 100.0 | 100.2 | 87.2 | 102.6 | not | not | not | not | not | not |
| | | | | | quantified | quantified | quantified | quantified | quantified | quantified |
| 2.03 | 100.0 | 100.2 | 87.2 | 102.6 | not | not | not | not | not | not |
| | | | | | quantified | quantified | quantified | quantified | quantified | quantified |
| 2.04 | 100.0 | 100.0 | 92.2 | 61.9 | 100.0 | 78.1 | 54.8 | 100.0 | 67.9 | 4.8 |
| 2.05 | 100.0 | 100.0 | 99.4 | 100.0 | 100.0 | 94.7 | 88.0 | 100.0 | 87.9 | 74.0 |
| 2.06 | 100.0 | 100.0 | 99.1 | 100.0 | 100.0 | 95.1 | 100.0 | 100.0 | 88.8 | 90.5 |
| 2.07 | 100.0 | 100.0 | 99.8 | 100.0 | 100.0 | 96.3 | 88.9 | 100.0 | 91.2 | not |
| | | | | | | | | | | quantified |
| 2.08 | 100.0 | 100.1 | 96.2 | 97.7 | 100.0 | 93.5 | 88.4 | 99.5 | 87.1 | 72.1 |
| 2.09 | 100.0 | 99.5 | 102.8 | 102.3 | 99.8 | 98.5 | 90.7 | 99.5 | 91.7 | 81.4 |
| 2.10 | 100.0 | 99.2 | 99.1 | 100.0 | 99.4 | 89.7 | 91.7 | 99.3 | 75.4 | 79.2 |
| 2.11 | 100.0 | 100.0 | 98.3 | 100.0 | 100.9 | 95.0 | 93.3 | 100.4 | 86.9 | 77.8 |
| 2.12 | 100.0 | 100.2 | 99.2 | 100.0 | 100.0 | 94.5 | 75.6 | 100.3 | 85.7 | 77.8 |
| 2.13 | 100.0 | 99.4 | 97.7 | 100.0 | 99.4 | 89.2 | 91.1 | 100.9 | 68.6 | 77.8 |
| 2.14 | 100.0 | 98.4 | 96.8 | 100.0 | 98.9 | 89.1 | 93.3 | 98.1 | 73.0 | 77.8 |
| 2.15 | 100.0 | 100.3 | 97.9 | 100.0 | 100.2 | 93.4 | 91.3 | 100.1 | 84.1 | 71.7 |
| 2.16 | 100.0 | 97.8 | 96.8 | 99.2 | 100.0 | 87.2 | 91.6 | 100.0 | 69.5 | 80.7 |
| 2.17 | 100.0 | 99.3 | 99.3 | 100.7 | 100.6 | 95.2 | 93.4 | 102.8 | 90.1 | 82.9 |
| 2.18 | 100.0 | 99.6 | 98.9 | 99.5 | 101.0 | 94.1 | 92.9 | 101.5 | 77.8 | 81.0 |
| 2.19 | 100.0 | 99.4 | 98.3 | 99.0 | 100.7 | 92.5 | 91.6 | 100.0 | 81.6 | 81.1 |
| 2.20 | 100.0 | 99.6 | 99.3 | 100.0 | 100.3 | 95.4 | 93.6 | 102.1 | 90.3 | 85.1 |
| 2.21 | 100.0 | 101.6 | 99.0 | 100.0 | 99.1 | 96.3 | 91.5 | 100.5 | 93.4 | 78.7 |
| 2.22 | 100.0 | 100.3 | 99.8 | 100.0 | 102.0 | 97.8 | 93.3 | 103.6 | 95.9 | 82.2 |
| 2.23 | 100.0 | not | not | not | not | not | not | not | not | not |
| | | quantified | quantified | quantified | quantified | quantified | quantified | quantified | quantified | quantified |
| 2.24 | 100.0 | 99.4 | 100.0 | 100.0 | 100.1 | 98.2 | 92.9 | 101.3 | 94.3 | 81.0 |
| 2.25 | 100.0 | 100.3 | 100.4 | 100.0 | 101.7 | 97.5 | 93.0 | 104.1 | 95.0 | 81.4 |
| 2.26 | 100.0 | 99.8 | 100.0 | 99.3 | 100.0 | 98.3 | 92.9 | 101.0 | 95.3 | 79.6 |
| 2.27 | 100.0 | 99.5 | 99.6 | 100.2 | 100.2 | 95.0 | 91.1 | 100.1 | 88.1 | 74.5 |
| 2.28 | 100.0 | 99.9 | 99.8 | 101.4 | 100.5 | 100.4 | 93.9 | 100.6 | 98.8 | 81.2 |
| 2.29 | 100.0 | 98.7 | 99.8 | 100.5 | 100.2 | 99.0 | 93.3 | 100.7 | 97.9 | 80.0 |
| 2.30 | 100.0 | 99.6 | 99.8 | 98.0 | 100.0 | 97.2 | 86.6 | 101.2 | 87.7 | 75.5 |
| 2.31 | 100.0 | 100.2 | 100.4 | 98.7 | 100.0 | 97.5 | 91.7 | 103.0 | 97.3 | 80.4 |
| 2.32 | 100.0 | 100.1 | 101.0 | 100.3 | 99.3 | 99.0 | 92.5 | 99.7 | 99.2 | 79.9 |
| 2.33 | 100.0 | 100.9 | 100.8 | 100.0 | 98.5 | 99.2 | 90.0 | 98.7 | 99.6 | 75.0 |
| 2.34 | 100.0 | 100.0 | 100.0 | 97.6 | 100.3 | 99.8 | 90.5 | 100.3 | 98.7 | 73.8 |
| 2.35 | 100.0 | 98.4 | 98.9 | 99.5 | 97.7 | 98.9 | 91.9 | 98.2 | 97.5 | 76.6 |
| 2.36 | 100.0 | 100.3 | 99.6 | 100.6 | 101.9 | 97.9 | 94.2 | 102.0 | 94.4 | 79.2 |
| 2.37 | 100.0 | 96.4 | 100.6 | 100.0 | 99.1 | 98.7 | 93.2 | 98.2 | 98.7 | 80.4 |
| 2.38 | 100.0 | 100.0 | 99.2 | 97.8 | 102.5 | 97.7 | 94.1 | 101.1 | 95.3 | 79.1 |
| 2.39 | 100.0 | 99.8 | 98.6 | 98.7 | 102.5 | 76.5 | 86.1 | 100.3 | 50.0 | 72.0 |
| 2.40 | 100.0 | 99.5 | 89.4 | 107.5 | 97.2 | 53.9 | 88.2 | 100.7 | 21.4 | 70.2 |
| 2.41 | 100.0 | 101.5 | 100.5 | 101.4 | 101.1 | 100.0 | 95.1 | 101.6 | 97.2 | 82.4 |
| 2.42 | 100.0 | 100.9 | 99.1 | 99.8 | 102.1 | 98.4 | 67.4 | 100.4 | 98.3 | 51.0 |
| 2.43 | 100.0 | 99.6 | 99.8 | 100.0 | 99.5 | 100.5 | 103.1 | 102.1 | 98.7 | 89.4 |
| 2.44 | 100.0 | 99.1 | 98.8 | 100.2 | 101.8 | 97.0 | 93.3 | 102.7 | 92.9 | 82.1 |
| 2.45 | 100.0 | 98.8 | 99.4 | 77.4 | 99.0 | 94.6 | 3.9 | 94.4 | 87.1 | 0.0 |
| 2.46 | 100.0 | 100.7 | 98.3 | 99.3 | 102.0 | 92.4 | 93.4 | 102.4 | 87.8 | 83.5 |
| 2.47 | 100.0 | 102.0 | 102.0 | 100.9 | 100.1 | 102.2 | 93.6 | 99.4 | 96.0 | 81.2 |
| 2.48 | 100.0 | 99.8 | 98.1 | 102.2 | 99.9 | 97.1 | 101.6 | 100.7 | 92.6 | 95.2 |
| 2.49 | 100.0 | 102.4 | 97.6 | 100.3 | 102.9 | 91.0 | 99.2 | 104.4 | 84.3 | 81.7 |
| 2.50 | 100.0 | 100.3 | 99.6 | 99.8 | 100.7 | 97.1 | 94.1 | 101.6 | 93.9 | 82.0 |
| 2.51 | 100.0 | 99.5 | 99.6 | 100.9 | 100.2 | 97.6 | 94.3 | 101.1 | 95.5 | 83.0 |
| 2.52 | 100.0 | 99.5 | 99.6 | 100.2 | 99.8 | 99.1 | 93.2 | 99.5 | 98.7 | 83.1 |
| 2.53 | 100.0 | 100.1 | 99.8 | 99.5 | 101.0 | 95.5 | 93.1 | 102.1 | 90.4 | 83.3 |
| 2.54 | 100.0 | 100.5 | 99.8 | 102.4 | 101.4 | 100.2 | 103.9 | 102.3 | 95.2 | 96.3 |
| 2.55 | 100.0 | 100.7 | 99.1 | 100.0 | 100.7 | 95.2 | 100.2 | 101.1 | 90.7 | 98.0 |
| 2.56 | 100.0 | 99.5 | 99.3 | 101.9 | 100.3 | 97.9 | 100.0 | 101.1 | 96.3 | 96.2 |
| 2.57 | 100.0 | 100.3 | 100.7 | 100.0 | 100.4 | 91.0 | 100.0 | 100.7 | 98.3 | 96.2 |
| 2.58 | 100.0 | 100.2 | 99.2 | 102.0 | 101.9 | 95.4 | 107.8 | 102.2 | 91.6 | 103.9 |
| 2.59 | 100.0 | 100.5 | 100.2 | 100.6 | 102.1 | 95.9 | 101.6 | 102.4 | 93.6 | 98.6 |
| 2.60 | 100.0 | 101.5 | 98.6 | 99.8 | 102.6 | 97.6 | 96.4 | 102.8 | 89.7 | 80.0 |
| 2.61 | 100.0 | 99.1 | 100.8 | 100.2 | 99.1 | 100.4 | 95.2 | 100.5 | 95.2 | 80.9 |
| 2.62 | 100.0 | 100.4 | 100.6 | 101.4 | 100.5 | 99.3 | 93.2 | 101.5 | 93.9 | 81.5 |
| 2.63 | 100.0 | 98.4 | 97.8 | 99.3 | 99.7 | 98.3 | 94.5 | 100.5 | 93.8 | 77.8 |
| 2.64 | 100.0 | 99.7 | 100.4 | 99.8 | 100.6 | 96.1 | 95.3 | 103.2 | 94.8 | 80.9 |
| 2.65 | 100.0 | 100.7 | 98.7 | not | 102.0 | 97.7 | not | 104.9 | 83.8 | not |
| | | | | quantified | | | quantified | | | quantified |
| 2.66 | 100.0 | 100.0 | 99.3 | not | 99.5 | 94.9 | not | 103.0 | 82.4 | not |
| | | | | quantified | | | quantified | | | quantified |
| 2.67 | 100.0 | 99.7 | 102.8 | not | 100.1 | 99.3 | not | 100.5 | 85.0 | not |
| | | | | quantified | | | quantified | | | quantified |
| 2.68 | 100.0 | 100.7 | 99.2 | 100.3 | 102.0 | 95.5 | 92.5 | 102.8 | 90.7 | 79.9 |
| 2.69 | 100.0 | 99.6 | 92.8 | 99.8 | 100.4 | 65.7 | 90.4 | 99.8 | 33.9 | 61.6 |
| 2.70 | 100.0 | 101.5 | 94.1 | 100.0 | 98.8 | 45.2 | 100.0 | 101.4 | 43.4 | 84.3 |
| 2.71 | 100.0 | 100.0 | 100.0 | 100.0 | not | not | not | 23.0 | 92.0 | 25.0 |
| | | | | | quantified | quantified | quantified | | | |
| 2.72 | 100.0 | 100.0 | 100.0 | 100.0 | not | not | not | 23.1 | 94.9 | 0.0 |
| | | | | | quantified | quantified | quantified | | | |
| 2.73 | 100.0 | 97.8 | 97.3 | 100 | 99.8 | 86.7 | 79.3 | 99.8 | 71.0 | 54.2 |
| 2.74 | 100.0 | 100.0 | 98.4 | 92.9 | 99.6 | 82.1 | 78.6 | 100.8 | 47.9 | 25.0 |
| 2.75 | 100.0 | 99.2 | 99.3 | 102.2 | 100.9 | 97.5 | 100 | 102.1 | 97.2 | 91.3 |

“Non-quantified” samples may be related to any of the following items: 1) aspects related to sample preparation for quantification of the actives; 2) samples having some type of physical-chemical instability such as those listed in table 1.

Having described examples of preferred embodiments of the present invention, it should be understood that the scope of the present invention encompasses other possible variations, being limited only by the content of the appended claims, including any possible equivalents thereof.

1. A formulation, characterized by comprising:
at least one or more active ingredients containing the acid function;
at least one or more active ingredients containing the ester function;
optionally, at least one or more salt and/or chemically labile active ingredients; and
optionally, at least one or more chemically suitable solvents and/or surfactants,
wherein said formulation further comprises:
at least one or more tertiary alkylamines;
at least one or more alkyl lactates; and
at least one or more acylating agents.

2. The formulation according to claim 1, characterized in that it is a herbicide formulation, wherein:
(i) the at least one or more active ingredients containing the acid function are selected from the following classes of acids: carboxylic acid, phosphoric acid, phosphonic acid, phosphinic acid, sulfuric acid, sulfonic acid, carbonic acid, phenol, 1,3-dicarbonyls and derivatives thereof;
(ii) the at least one or more active ingredients containing the ester function is selected from lactofen, carfentrazone ethyl, pyrazosulfuron ethyl, quizalofop ethyl, haloxyfop methyl, fenoxaprop ethyl, clodinafop propargyl, cialofop butyl, diclofop methyl, and fluazifop butyl;
(iii) the at least one or more salt and/or chemically labile active ingredients is selected from bispyribac sodium, pyrithiobac sodium, tolpiralate, fomesafen sodium, ammonium glyphosinate, metamifop, tridiphane, indanofan, thenilchlor, propisochlor, propachlor, pretilachlor, metolachlor, pethoxamid, alachlor, butachlor, dimetachlor, metazachlor and dimethenamid;
(iv) the at least one or more chemically suitable solvents is a chemically suitable solvent selected from aprotic solvents.

3. The formulation according to claim 1, characterized in that the, at least, one or more tertiary alkylamines is selected from triethylamine, tripropylamine, triisopropylamine, tributylamine, and diisopropylethylamine.

4. The formulation according to claim 1, characterized in that the, at least, one or more alkyl lactates is selected from methyl lactate, ethyl lactate, n-propyl lactate, iso-propyl lactate, and ethyl hexyl lactate.

5. The formulation according to claim 1, characterized in that the, at least, one or more acylating agents are selected from acetic anhydride, propionic anhydride, phthalic anhydride and acyl chlorides of different carbon chain sizes.

6. The formulation according to claim 1, characterized in that it is a herbicide formulation comprising:
2,4-dichlorophenoxyacetic acid (2,4-D) as an acid function-containing active ingredient,
lactofen as an ester function-containing active ingredient,
bispyribac sodium as a salt and/or chemically labile active ingredient.

7. The formulation according to claim 6, characterized in that it further comprises:
(i) at least one or more tertiary alkylamines, wherein the at least one or more tertiary alkylamines is selected from triethylamine, tripropylamine, triisopropylamine, tributylamine, and diisopropylethylamine;
(ii) at least one alkyl lactate selected from methyl lactate, ethyl lactate, n-propyl lactate, iso-propyl lactate, and ethyl hexyl lactate;
(iii) at least one acylating agent selected from acetic anhydride, propionic anhydride, phthalic anhydride and acyl chlorides of different carbon chain sizes.

8. The formulation according to claim 1, characterized in that it is a herbicide formulation comprising:
from 100 to 800 g/L 2,4-dichlorophenoxyacetic acid (2,4-D) as an active ingredient containing the acid function;
from 10 to 400 g/L lactofen as an active ingredient containing the ester function;
from 2.5 to 200 g/L bispyribac sodium as a salt and/or chemically labile active ingredient;
wherein the composition further comprises triethylamine in an amount of from 0.8 to 3.0 times the molar amount relative to the acid; from 10 to 100 g/L of ethyl lactate; from 10 to 100 g/L acetic anhydride; from 5 to 150 g/L one or more surfactants; and solvent q.s.p.

9. The formulation according to claim 8, characterized in that it is a herbicide formulation comprising:
from 400 to 600 g/L 2,4-dichlorophenoxyacetic acid (2,4-D) as an active ingredient containing the acid function;
from 40 to 100 g/L lactofen as an active ingredient containing the ester function;
from 4 to 20 g/L bispyribac sodium as a salt and/or chemically labile active ingredient;
wherein the composition further comprises triethylamine in an amount of from 1.0 to 2.0 times the molar amount relative to the acid; from 20 to 50 g/L ethyl lactate; from 20 to 40 g/L acetic anhydride; from 10 to 50 g/L surfactant; and solvent: q.s.p.

10. The formulation according to claim 1, characterized in that it is a herbicidal formulation of the type emulsifiable concentrate, oil-miscible fluid concentrate (OF), oil-miscible solution (OL) and oil dispersion (OD).

11. An use of a tertiary alkylamine, an alkyl lactate, an acylating agent and, optionally, one or more suitable solvents in a formulation, as defined in claim 1, characterized in that as a single formulation it is to prevent and/or reduce the degradation of active ingredients that are chemically incompatible with each other and/or that are degraded by a reaction caused by nucleophiles.

12. The use according to claim 11, characterized in that the tertiary alkylamine is selected from triethylamine, tripropylamine, triisopropylamine, tributylamine, and diisopropylethylamine.

13. The use according to claim 11, characterized in that the alkyl lactate is selected from methyl lactate, ethyl lactate, n-propyl lactate, iso-propyl lactate, and ethyl-hexyl lactate.

14. The use according to claim 11, characterized in that the acylating agent is selected from acetic anhydride, propionic anhydride, phthalic anhydride and acyl chlorides of different carbon chain sizes.

15. An use of a formulation, as defined in claim 1, characterized in that it is to prevent and/or reduce the degradation of active ingredients that are chemically incompatible with each other and/or that are degraded by a reaction caused by nucleophiles.

16. A method of preparing a formulation, as defined in claim 1, characterized in that it comprises the steps of:
(a) adding the at least one or more chemically suitable solvents and at least one or more alkyl lactates;
(b) adding to the solution obtained in step (a) the at least one or more tertiary alkylamines followed by at least one or more active ingredients containing the acid function, controlling the temperature and stirring the mixture;
(c) stirring until total dissolution of the at least one or more acid function containing-active ingredients and up to a suitable temperature of the reaction medium;
(e) adding at least one or more acylating agents, followed by the salt and/or chemically labile active ingredient(s), followed by stirring until the salt is completely dissolved; and
(f) adding the at least one or more ester function-containing active ingredients; optionally stirring the mixture obtained until a homogeneous mixture is achieved, and optionally adding additional components, such as surfactants, emulsifiers, dispersants, surfactants and/or others.

17. A method of use of a tertiary alkylamine, an alkyl lactate, an acylating agent and, optionally, one or more suitable solvents in a formulation, as defined in claim 1, characterized in that it is to achieve a single formulation.

18. The method according to claim 17, characterized in that the tertiary alkylamine is selected from triethylamine, tripropylamine, triisopropylamine, tributylamine, and diisopropylethylamine.

19. The method according to claim 17, characterized in that the alkyl lactate is selected from methyl lactate, ethyl lactate, n-propyl lactate, iso-propyl lactate, and ethyl- hexyl lactate.

20. The method according to claim 17, characterized in that the acylating agent is selected from acetic anhydride, propionic anhydride, phthalic anhydride and acyl chlorides of different carbon chain sizes.
